(19) United States
(12) Patent Application Publication
(10) Pub. No.: US 2025/0031793 A1
(43) Pub. Date: Jan. 30, 2025

(54) PROTECTIVE CAP CONFIGURED TO BE WORN OVER A HELMET BY AN OPERATOR

(71) Applicant: THI TOTAL HEALTHCARE INNOVATION S.R.L., Rovigo RO (IT)

(72) Inventor: Giorgio ROSATI, San Cesareo RM (IT)

(73) Assignee: THI TOTAL HEALTHCARE INNOVATION S.R.L., Rovigo RO (IT)

(21) Appl. No.: 18/705,218

(22) PCT Filed: Nov. 25, 2022
(86) PCT No.: PCT/IB2022/061422

§ 371 Date: Apr. 26, 2024

(30) Foreign Application Priority Data
Nov. 26, 2021 (IT) 102021000029954

(51) Int. Cl. A42B 1/018; A41D 13/11; A42B 3/18; A42B 3/28

(52) U.S. Cl. CPC A42B 1/018; A41D 13/1153; A41D 13/1184; A42B 3/18; A42B 3/286

(57) ABSTRACT

A protective cap for surgical use which is adapted to be worn, in sterile form, by an operator above an instrumented helmet is disclosed. The gap includes a front vision lens, an enveloping main body fixed to the vision lens which is configured to wholly cover the operator's head, neck and an upper part of the chest. The enveloping main body also includes a filtering portion for viral and bacterial agents.

### TECHNICAL FIELD OF THE INVENTION

The present invention relates to a cap, or hood, of the type used by an healthcare operator, in particular a surgeon, in association with a protective helmet.

The cap, or hood, can be of disposable type.

### BACKGROUND

As it is known, the current surgical procedures provide that the physician wears a protective helmet, generally an instrumented helmet, thereabove a cap, or hood, is worn for protecting the surgeon herself/himself from infecting agents and biological materials of the patient. The cap covers the helmet, and then the subject's head, as well as the head and part of chest. The cap is supplied folded under sterility conditions and includes a vision lens, or a transparent portion, to be positioned at a dedicated opening of the helmet.

Above the cap, or better of the thoracic portion thereof, a gown is then worn, generally of disposable type.

The above-mentioned dressing apparatus, as said, aims at guaranteeing conditions of complete external sterility of the operating surgeon and, due to its nature, it results to be quite complex.

An example of a system of the mentioned type having improved wearability is described in WO2021/099881A1.

Notwithstanding the complexity of the proposed system, which includes a plurality of components worn together and at least partially overlapped, there are still critical issues relating to the surgeon protection from viruses and bacteria potentially present in surgical environment.

The same drawbacks occur even in relation to other applications of the cap of the above-mentioned type, not necessarily medical applications, and other operators, not necessarily healthcare operators, for example in the so-called “clean rooms” of the research and experimental laboratories, where it can be relevant to filter even the air emitted by the operator before releasing it again in the environment.

### SUMMARY OF THE INVENTION

The technical problem placed and solved by the present invention then is mainly to provide a cap, or hood, of the above-mentioned type allowing to improve the protection of the operator, in particular a surgeon, from viruses and bacteria.

Such problem is solved by a cap, or hood, according to claim 1.

Preferred features of the present invention are set forth in the depending claims.

In the context of the present description, terms such as “sagittal”, “front”, “anterior”, “lateral”, “posterior”, “upper”, “lower” and derivatives are assigned to elements of the cap or positions thereof and referred to the worn configuration of the cap itself, even in association with the anatomical definitions of the body of the operator wearing it.

In general terms, the cap of the invention is of the type suitable to cover wholly, or almost wholly, the operator's head, neck and upper part of the chest.

According to the invention, the cap includes a filtering portion configured to screen viral and bacterial agents, arranged at a median-posterior part of the head. Preferably, such filtering portion is configured to cover, in use, one or more air inlet mouths of the helmet worn under the cap.

In particular, the helmet to be used with the cap of the invention includes means for ventilating the environment inside thereof, suitable to allow the supply of a “fresh” air flow at the operator's face and an optimum air exchange within said environment. The combination of such helmet equipped with ventilation means with the above-mentioned filtering portion of the cap allows to increase the operator's well-being and to reduce the risk of infection, to the advantage of the health in general and of the performance of the operator herself/himself.

Other advantages, features and use modes of the present invention will result evident from the following detailed description of embodiments thereof, shown by way of example and not for limitative purposes.

### BRIEF DESCRIPTION OF FIGURES

The figures of the enclosed drawings will be referred to, wherein:

FIGS. 1A, 1B and 1C show a schematic side, front and rear view, respectively, of a preferred embodiment of the cap according to the present invention;

FIG. 2 shows a side perspective view of a surgical helmet to be used together with the cap of the invention, exemplifying by arrows the air flows through the helmet and the cap themselves; and

FIG. 3 shows a front perspective view of an operator wearing the helmet of FIG. 2.

### DETAILED DESCRIPTION OF PREFERRED EMBODIMENTS

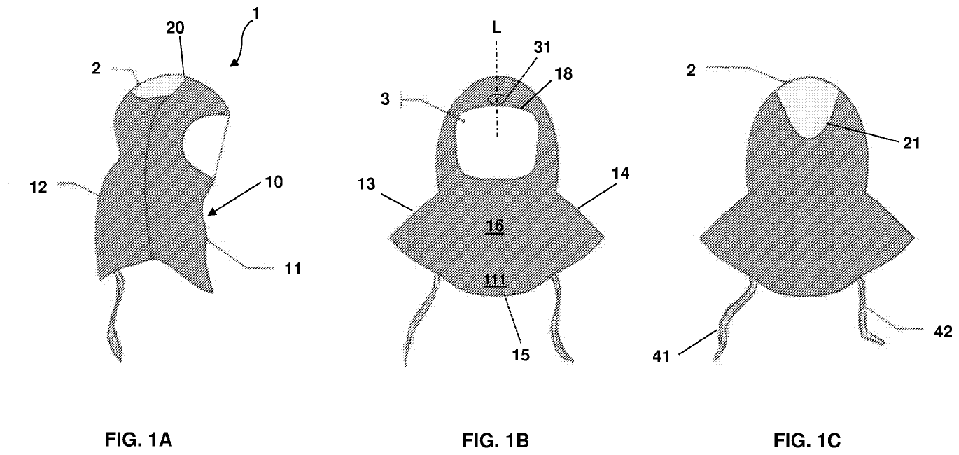

With reference to FIGS. 1A, 1B and 1C, a cap according to a preferred embodiment of the invention is designated as a whole with 1. The cap 1 is adapted to be worn by a surgeon during an operation in the operating room.

Application variants can provide a use in other contexts in which a, in particular sterile, piece of clothing or harness is required, for example a clean room of a laboratory.

The cap 1 is adapted to be sterilized and provided folded in a package, sterile too, according to modes known in the art.

In the present embodiment, the cap 1 is of disposable type.

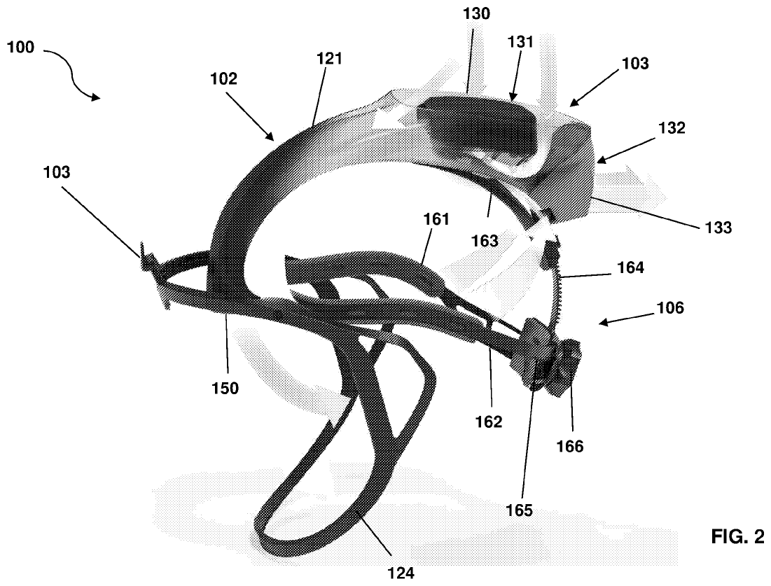

The cap 1 is meant to be worn over an instrumented surgical helmet, the latter schematically shown in FIG. 2 and herein designated with 100.

The cap 1 generally is symmetrical with respect to its own longitudinal axis L which, in use, substantially corresponds to the sagittal plane trace of the operator wearing it.

On the cap 1 an internal face, or side, 15 and an external face, or side, 16 can be identified, so defined since the first one, after wearing, is facing towards, or in direct contact with, the operator's body whereas the second one is indeed facing towards the external environment.

The cap is configured to cover wholly the head, neck and upper chest of the operator wearing it and this by means of its own enveloping main body 10. The latter is made of a flexible material and preferably made of fabric.

The main body 10 is fixed, at its own front opening 18, on a peripheral region of a front vision lens 3. The latter, in use, positions at least at the operator's eyes, preferably extending on a wide part of the subject's face so as to guarantee an adequate and comfortable field of vision during the surgical operation.

With also reference to FIG. 2, the vision lens 3 can have means for connecting to the surgical helmet 100, in particular coupling means 31, for example in form of through-hole, suitable to engage a corresponding element, for example a hook-like appendix 103, of the surgical helmet 100.

The main body 10 of the cap 1 is advantageously implemented in one single piece. A front portion 11 and a rear portion 12 can be identified thereon, connected and made integral by means of two opposite side portions 13 and 14.

The front portion 11 can have a lower appendix 111 shaped like a bib, which, in use, extends on the operator's chest. Preferably, it has squared, that is polygonal, shape or shape with arched terminal edge (as in the example shown in FIG. 1B). The remaining peripheral edges of the main body 10, in particular at the rear portion 12 and side portions 13, 14, have generally rounded or arched profile.

The bib-like appendix 111 can determine a greater longitudinal extension for the front portion 11 than for the rear one 12.

On the rear portion 12 of the main body 10 respective longitudinal ends of a first and a second lateral tie rod, respectively 41 and 42, are fixed, arranged on opposite sides with respect to the longitudinal axis L, that is to the sagittal plane of the operator. The tie rods 41 and 42 are configured to be mutually tied on the front side to the main body 10 to fix it in position close to the operator's body.

As a whole, in the herein described elements the cap 1 can be implemented in accordance with the teachings of WO2021/099881A1.

The main body 10 includes a portion 2 made of a filtering fabric suitable to screen the entry of viral or bacterial agents. The filtering portion 2 is arranged at the upper and medium-posterior part of the main body itself, that is a portion which, in use, arranged indeed on the operator's head, in apical and medium-posterior position thereof. In the represented example, the filtering portion 2 has a front edge 20 arranged at the horizontal centreline of the head, in case in association to a sewing or welding line of vertical centreline of the main body 10. On the rear side, the filtering portion 2 has an arched profile 21 covering a parietal part of the skull. In the illustrated example, such rear part of the filtering portion 2 bears centrally converging edges and then a downwardly tapered shape.

The enveloping body 10 can be implemented, for example, in a polypropylene tri-laminate in all its portions with the exception of the filtering portion 2, for example made of a material in four layers with filtering and breathable effect, consisting of two external layers of spundbond of polypropylene and one internal layer consisting of a mix of filtering synthetic fibers stretched out on a layer of polypropylene with carrier effect.

In particular, in an embodiment variant the material with four layers of the filtering portion 2 is 115 g/m² and it comprises, or it only consists of: Blended Synthetic Fibres & Spunbond Polypropylene, Coverweb Spunbond Polypropylene 15 g/m², Blended Synthetic Fibre 70 g/m², Carrier Spunbond Polypropylene 15 g/m², Coverweb Spunbond Polypropylene 15 g/m².

In a preferred embodiment, the material of the remaining part of the enveloping body 10 can consist of, or include, a non-woven fabric material, in particular thinner and lighter (68 g/m²) than the one of the filtering portion and advantageously definable as Breathable Viral Barrier.

Advantageously, in a preferred embodiment the filtering portion 2 is joined to the remaining and surrounding part of the enveloping body 10 by ultrasound welding, without requiring sewing.

The ultrasound junction involves several advantages with respect to the welding and other joining methods, since it allows to connect and made integral different materials without using threads or adhesives and above all without perforating the tissues with needles which obviously would wholly jeopardize their capability of barrier effect to bacteria and viruses. Through this junction technique it is possible to minimize the thermal distortion of the non-woven fabric or, generally, of the material of the remaining part of the enveloping body involved by the junction, thus maintaining the softness and the specificities of the material itself.

Advantageously, an ultrasound welding machine can be used, with selected adjustments, in terms of pressure and then friction, equipped with specific rollers with pattern and rotating sonotrode.

In an exemplifying and not limiting embodiment, the features of the filtering material are the ones indicated below.

### Effectiveness of the Filtering Performances

| | |
|---|---|
| NaCl penetration | Tested in accordance to TSI8130 NaCl |
| at 32 LPM < 6.00% | 0.1-micron particle size |
| NaCl effectiveness | Tested in accordance to TSI8130 NaCl |
| at 32 LPM > 94.00% | 0.1-micron particle size |
| Pressure decrease | Tested in accordance to TSI8130 NaCl |
| at 32 LPM < 0.7 mm H2O | 0.1-micron particle size |
| BFE average | Reference Study #: 1311706-S01 |
| effectiveness (40 CM2) 99.90% | Test Protocol (STP0009 REV 14) |
| VFE average | Reference Study #: 1311707-S01 |
| effectiveness (40 CM2) 99.53% | Test Protocol (STP0010 REV 15) |
| Air permeability > 275 CFM | Tested in accordance to ASTM Spec |
| | ASTM D737 |

The standard procedure for testing the effectiveness of viral filtration was modified so as to be more severe than the normal use; however, the test is performed in accordance to US FDA good manufacturing practice (GMP) regulations 21 CFR Parts 210, 211 and 820.
Challenge Flow Rate: 30 LPM (litres per minute)
Tested Area: ˜40 cm2
Tested Side: both sides
Critical level: 6.2×10⁶ PFU for VFE and 2.2×10⁶ CFU for BFE
MPS: ˜2.9 μm

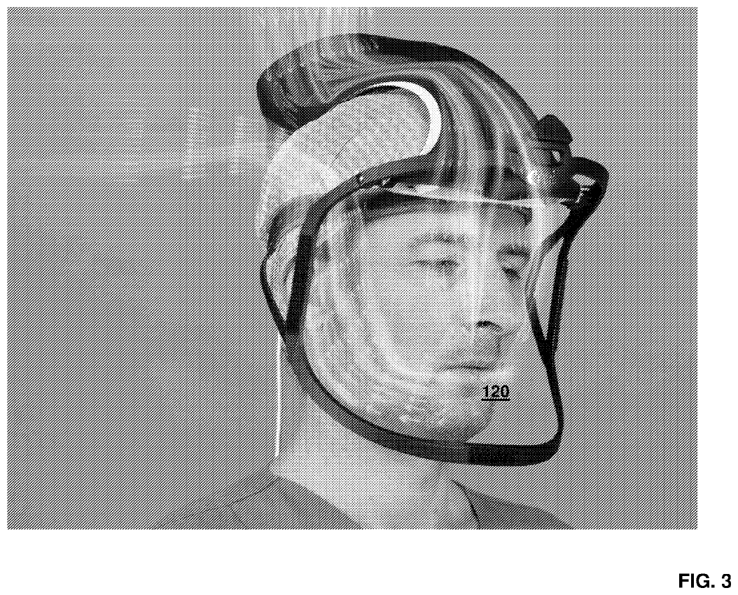

As far as the surgical helmet 100 is concerned, this is illustrated schematically in FIGS. 2 and 3.

The helmet 100 has a main body of helmet 102 substantially in form of helmet, apt to surround the operator's head.

The main body 102 has a bearing structure mainly implemented by a sagittal upright 121 having curved shape which substantially follows the profile of the operator's head according to the sagittal plane of the latter.

The sagittal upright 121 is joined on the front side to an additional front structural element 124 substantially shaped like polygonal mask and in particular substantially rectangular. The front mask 124 defines a central compartment adapted to be closed again by the transparent vision element 3 integral to the cap 1.

The helmet 100 further comprises forced air circulation means, designated as a whole with 103, within an environment, designated with 120, housing the surgeon's head and which is defined and closed externally by the main body of helmet 102, by the lens 3 and by the cap 1.

In the present example, the forced air circulation means 103 comprises first and second ventilation means, respectively 131 and 132, typically implemented by means of axial or radial blowers of the type known per se. The means 131 and 132 are housed within an internal and rear compartment of the sagittal upright 121. Such first and second ventilation means 131 and 132, for example, are battery powered.

The first ventilation means 131 is means for inletting “fresh” air within the environment 120 and to this purpose it is equipped with a suction mouth 130.

The second ventilation means 132, instead, is means for sucking exhaust air from the environment 120, which then allows an evacuation of said exhaust air from such environment and then a decrease in content of CO₂. To this purpose, the means 132 is equipped with an air outlet 133. Such flows entering and outgoing through the mouths 130 and 133 are exemplified by arrows in FIG. 2.

On the external part of the upright 121 the forced circulation means 103 can provide flanges coupling with the cap 1.

Preferably, means is provided for controlling the flow and/or rate of the air entered and/or evacuated by the ventilation means 131 and 132. In the present example such control means is incorporated in a control unit, preferably positioned at an apical portion of the upright 121, in front of the ventilation means 131 and 132.

Advantageously, the control unit and/or the ventilation means comprise means for actuating the latter, in case of touchless type.

As exemplified in FIGS. 2 and 3 by means of arrows, in order to favour the forced air circulation within the environment 120 the bearing structural element 121 preferably has a tube-like shape, in the sense that it results to be internally hollow and in communication with the environment 120 by means of a respective front opening or loophole 150. In this way, the bearing element 121 guides the air flow entering the environment 120 generated by the forced circulation means 103.

The hollow configuration of the upright 121 also determines a considerable lightening of the helmet 100.

The overall configuration obtained with the arrangement of the ventilation means 131 and 132 then is so that the air is entered within the environment 120 by the means 131 and through the sagittal upright 121 and the front opening 150 of the latter and thus conveyed towards the front area defined by the mask 124. As exemplified by the arrows in FIGS. 2 and 3, the “fresh” air flow with adequate oxygen content laps the operator's face, at a central portion thereof, from top to bottom, and it is called back laterally the face itself, at the skin and jaws, by going back towards the ventilation means 132, providing the flow of exhaust air, mainly exhaled following the operator's breathing, towards the outside.

The sucking through the means 132 occurs by means of a suction force generated by the latter at the rear part of the sagittal upright 121. As said, the air passes laterally the operator's face and it is conveyed outside the environment 120.

The fact of placing the opening or loophole 150 of the sagittal upright 121 directly at the lens 3 allows a controlled air intake directly on the latter, by contrasting effectively the fogging thereof.

The filtering portion 2 of the main body 10 of the cap 1, in use, positions at the suction mouth 130 of the first ventilation means 131.

Preferably, the helmet 100 also comprises means for wearing the main body 102 on the operator's head and in particular a flexible structure 106 shaped substantially like a cover. It is implemented by two lateral bands 161 and 162 and by a sagittal band 163 placed below the upright 121.

The structure 106 further provides an azimuthal adjustment element 164, equipped with a sagittal toothing or equivalent engagement means, allowing an adjustment of the sagittal (azimuthal) position of the main body 102 with respect to the operator's head by engaging, for example, a corresponding peripheral toothing of the sagittal band 163.

The structure 106 further comprises a peripheral adjustment element 165, comprising a cross, or peripheral, toothing which engages corresponding peripheral toothing of the bands 161 and 162. In this way an adjustment of the extension of the base periphery is allowed, indeed to allow to adapt the helmet 100 to the specific anthropometry of the subject wearing it.

Such double possibility of adjusting the positioning of the helmet 100 on the head increases the stability, in use, of the helmet itself and strongly improves the operator's comfort.

Advantageously, both peripheral and azimuthal adjustments can be obtained by means of one single knob 166, or equivalent adjustment means, arranged, in use, at the occipital part of the head.

The structure 106 is made integral to the main body 102 in selected points.

As a whole, the helmet can be implemented according to the devices described in WO2017/120562A2 or in WO2012/111030A1.

Preferably removable connection means is provided to constrain the main body of the helmet 102 to the cap 1. Advantageously—and as already anticipated above—in the present example such additional means is based upon a shape coupling between connection flanges of the main body 102 and corresponding complementary elements associated to the cap 1.

It will be appreciated that each one of the above-described embodiments, variants and configurations allows to optimize the conveyance of fresh air and the evacuation of the exhaust air in the environment housing the operator's head, with important advantages associated to the comfort of the operator herself/himself.

The present invention has been described sofar with reference to its preferred embodiments. It is to be meant that other embodiments belonging to the same inventive core may exist, as defined by the protective scope of the herebelow reported claims.

1. A protective cap
configured to be worn over a helmet by an operator, in particular in an operating room or clean room,
which protective cap comprises:
a front vision lens, configured to position-in-use, at least at the operator's eyes;
an enveloping main body, fixed to said vision lens at a peripheral region thereof and configured to completely cover the operator's head, neck and upper chest,
which enveloping main body comprises a front portion and a rear portion connected and made integral by two opposite side portions,
wherein said main body further comprises a filtering portion configured to screen viral and bacterial agents, which filtering portion is arranged at an upper and middle-rear part of the main body that is placed, on the operator's skull,
wherein said filtering portion is joined to a surrounding part of said main body by ultrasound welding.

2. The protective cap according to claim 1, wherein said front portion has a lower appendix shaped like a bib, which, extends on the operator's chest.

3. The protective cap according to claim 1, comprising a first and a second (42) lateral tie rod, each one fixed, at a respective terminal end, on said enveloping main body, said first and second tie rod being arranged on opposite sides with respect to a longitudinal axis of the cap and configured to be wrapped, at the end of wearing the cap, around the chest and connected to each other.

4. The protective cap according to claim 1, wherein said filtering portion comprises a rear portion having a downwardly tapered shape.

5. The protective cap according to claim 1, wherein said enveloping main body is made of polypropylene tri-laminate with the exception of said filtering portion.

6. The protective cap according to claim 1, wherein said filtering portion is made of a monolayer or multilayer filtering material suitable to guarantee a filtration of viruses and bacteria higher than 99%.

7. The protective cap according to claim 1, wherein said vision lens has connection means coupling means, to a surgical helmet.

8. The protective cap according to claim 1, which is sterilizable or supplied sterile in a package.

9. The protective cap according to claim 1, which is of disposable type.

10. An assembly comprising a protective cap according to claim 1 and a surgical helmet connectable to said vision lens, wherein said protective cap is adapted to be worn over said surgical helmet.

11. The assembly according to claim 10, wherein said helmet comprises forced air circulation means having ventilation means configured to suck in external air and said filtering portion of said cap is configured to be arranged, over a suction mouth of said ventilation means.

12. The assembly comprising a protective cap according to claim 1 and a gown that can be worn over a lower part of said enveloping main body.

13. The assembly according to claim 10, which is supplied as a kit.

14. A sterile package, which comprises a wrapping and a sterile protective cap according to claim 1, wherein said protective cap is housed in said wrapping in folded form.
